(19) United States
(12) Patent Application Publication
(10) Pub. No.: US 2014/0104198 A1
(43) Pub. Date: Apr. 17, 2014

(54) TOUCH SCREEN PEN WITH CLEANING FUNCTION

(71) Applicant: Tsung-Ching KAO, New Taipei City (TW)

(72) Inventor: Tsung-Ching KAO, New Taipei City (TW)

(21) Appl. No.: 13/730,013

(22) Filed: Dec. 28, 2012

(30) Foreign Application Priority Data
Oct. 12, 2012 (TW) 101219778

(51) Int. Cl. G06F 3/0354

(52) U.S. Cl. CPC G06F 3/03545
USPC 345/173

(57) ABSTRACT

A touch screen pen with cleaning function is revealed. The touch screen pen includes a pen body, at least one cleaning part and a drive mechanism. The pen body consists of a receiving space, a touch control end, a first opening and a second opening. The cleaning part is mounted in the receiving space and is able to be moved out and in through the first opening. The drive mechanism is arranged at the second opening and is connected to the cleaning part. By the drive mechanism, users can drive the cleaning part to move out through the first opening for wiping touch screens. Then the cleaning part is moved into the pen body for storage after being used.

### BACKGROUND OF THE INVENTION

The present invention relates to a touch screen pen, especially to a touch screen pen in which a cleaning part mounted in a pen body is driven by a drive mechanism to move out through an opening on the pen body for wiping touch screens. After being used, the cleaning part is moved into the pen body for storage.

Now portable electronics such as mobile phones, tablet computers, personal digital assistants, etc are disposed with a touch screen for users to operate manually by their fingers or hands. While in use, the touch screen may have fingerprints or dust over it and there may be no microfiber cloth available. Users need to prepare other manual or electronic cleaning devices for cleaning the touch screen in advance and carry the devices with them. For cleaning the touch screen, first they need to stop using the touch screen pen and take out the cleaning devices. The higher cost and inconvenience in carriage and use of the cleaning device cause users troubles.

In order to solve above problems, there are some patents such as Japanese Utility Pat. No. 6-86127, JP App. No. 2001-112684, JP Pat. 4555115. However, the techniques and devices revealed in these prior arts have more complicated structure and higher manufacturing cost. Moreover, they are not convenient in use and are unable to meet users' requirements.

Thus there is room for improvement and a need to provide a novel touch screen pen that is not only convenient to carry but also easy to use. When the touch screen need to be cleaned, a cleaning component disposed in the touch control panel is used for wiping and cleaning the touch screen. The users' needs are met.

### SUMMARY OF THE INVENTION

Therefore it is a primary object of the present invention to provide a touch screen pen with cleaning function that includes a cleaning part and a corresponding drive mechanism, both mounted in the touch screen pen. A touch control end of the touch screen pen is in contact with a touch screen of electronics for control of the touch screen. The cleaning part is driven by the drive mechanism to move out of the touch screen pen for cleaning the touch screen or move into the touch screen pen for storage.

In order to achieve the above object, a touch screen pen with cleaning function of the present invention includes a pen body, at least one cleaning part and a drive mechanism. The pen body has a receiving space therein, a touch control end disposed on a front end thereof, a first opening and a second opening. The first opening and the second opening are respectively communicating with the receiving space and the receiving space is communicating with space outside the pen body through the first opening. The cleaning part for wiping and cleaning touch screens is arranged in the receiving space of the pen body and is moved out or in through the first opening. The drive mechanism is inserted through and arranged at the second opening of the pen body. The drive mechanism is connected to one end of the cleaning part. By the drive mechanism, users can drive the cleaning part to move out through the first opening of the pen body for wiping touch screens. After being used, the cleaning part is moved in by the drive mechanism for storage in the pen body.

### BRIEF DESCRIPTION OF THE DRAWINGS

FIG. 1 is a schematic drawing showing an embodiment of a touch screen pen wiping an electronic device according to the present invention;

FIG. 2 is a schematic drawing showing an embodiment according to the present invention;

FIG. 3 is a schematic drawing showing a cross section of an embodiment while a cleaning part is moved in for storage according to the present invention;

FIG. 4 is a schematic drawing showing a cross section of an embodiment while a cleaning part is moved out for cleaning according to the present invention;

FIG. 5 is a schematic drawing showing a cross section of another embodiment according to the present invention;

FIG. 6 is a schematic drawing showing a cross section of a further embodiment according to the present invention;

FIG. 7 is a schematic drawing showing a cross section of a further embodiment according to the present invention;

FIG. 8 is a schematic drawing showing a cross section of a further embodiment added with a protection element according to the present invention;

FIG. 9 is a schematic drawing showing a cross section of a further embodiment added with a protection element according to the present invention.

### DETAILED DESCRIPTION OF THE PREFERRED EMBODIMENT

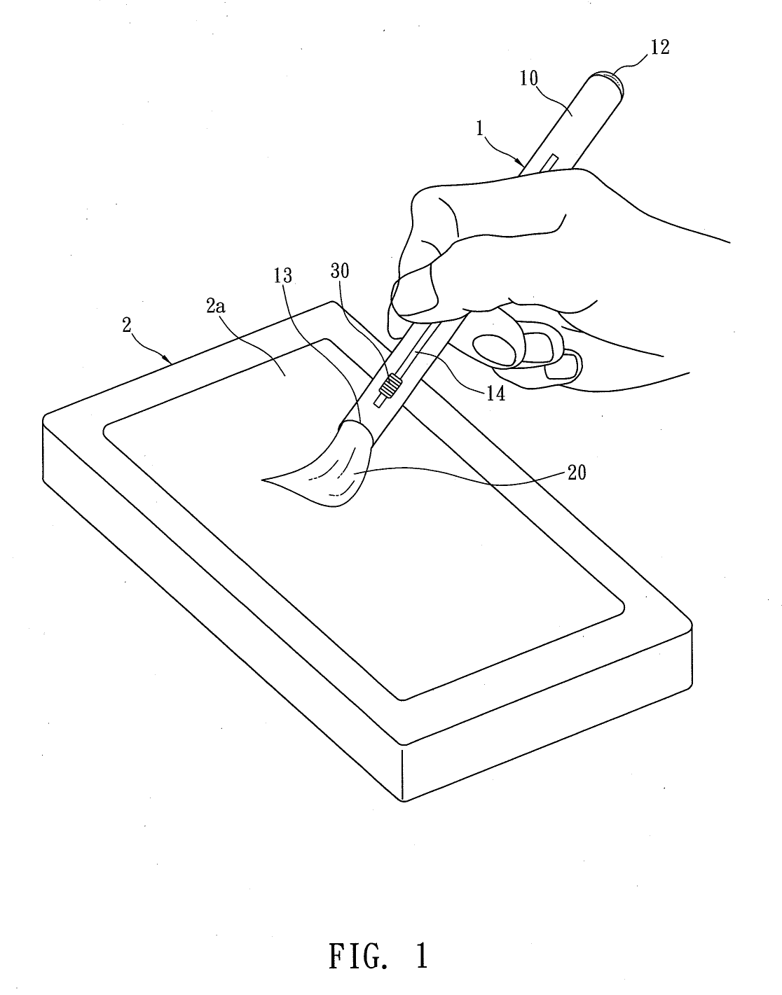

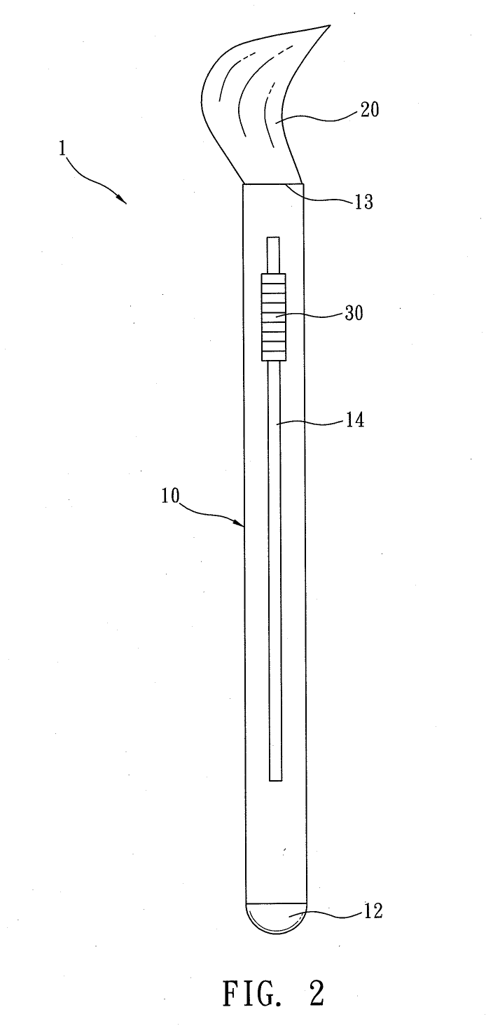

Refer from FIG. 1 to FIG. 4, a touch screen pen 1 with cleaning function of the present invention is used for an electronic device 2. The electronic device 2 including a touch screen 2a can be but not limited to a mobile phone, a personal digital assistant, a tablet computer or a global positioning system. The touch screen pen 1 consists of a pen body 10, at least one cleaning part 20 and a drive mechanism 30.

The pen body 10 includes a front end, a rear end, and a side surface with a certain length and formed between the front end and the rear end. The pen body is composed of a receiving space 11, a touch control end 12, a first opening 13 and a second opening 14. The pen body 10 is held by users and there is no limit on its shape. The pen body 10 can be a cylindrical tube, an elliptical tube, a square tube, a rectangular tube, a conic tube with the smaller front end and the larger rear end, and a pyramidal tube with the smaller front end and the larger rear end. The receiving space 11 is inside the pen body 10 while the touch control end 12 is disposed on the front end of the pen body 10 and is in contact with the touch screen 2a for easy operation such as writing messages.

The first opening 13 is arranged at the pen body 10, located at the position other than the touch control end 12 such as the rear end or side surface of the pen body 10 and communicating with the receiving space 11. Thus the receiving space 11 is communicating with space outside the pen body 10 through the first opening 13. The second opening 14 is disposed on the side surface or rear end of the pen body 10 and is used for mounting the drive mechanism 30. When the first opening 13 is disposed on the side surface of the pen body 10, the second opening 14 is arranged at the rear end of the pen body 10. If the first opening 13 is mounted on the rear end of the pen body 10, the second opening 14 is set on the side surface of the pen body 10. Moreover, the second opening 14 is communicating with the receiving space 11 so that the receiving space 11 is communicating with the space outside the pen body 10 through the second opening 14. The second opening 14 can also be not communicating with the space outside the pen body 10.

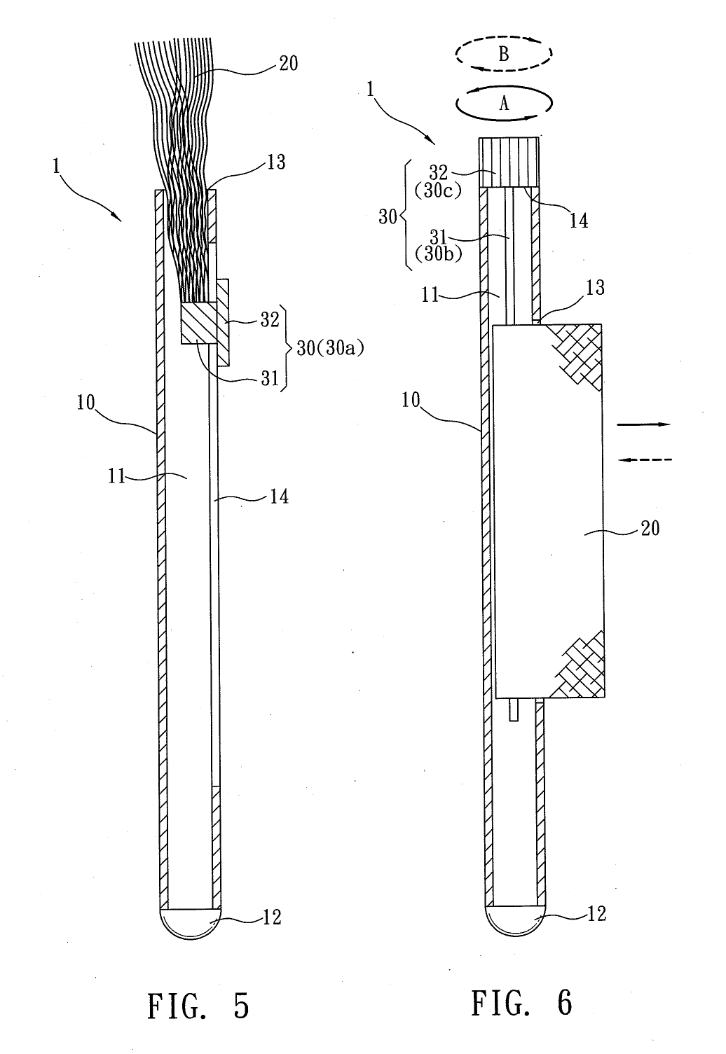

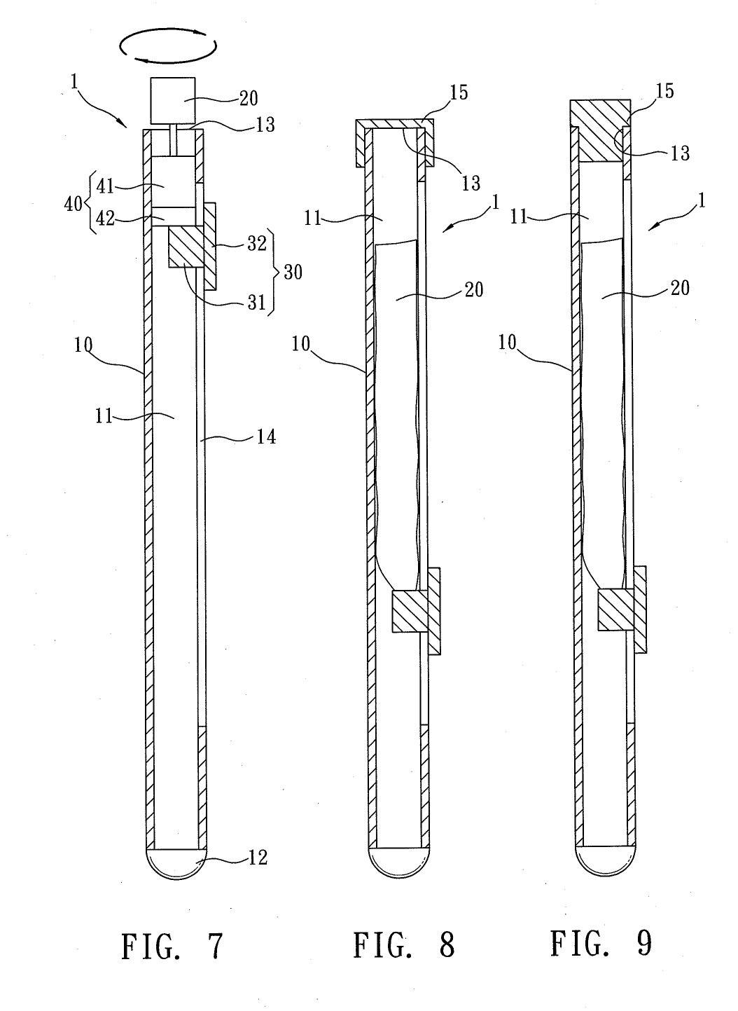

The cleaning part 20 is used to wipe and clean the touch screen 2a of the electronic device 2. The cleaning part 20 is loaded in the receiving space 11 of the pen body 10 and is corresponding to the first opening 13 of the pen body 10. The cleaning part 20 can be driven and moved out of the first opening 13 of the pen body 10 for performing wiping and cleaning. After finishing the cleaning, the cleaning part 20 is retracted into the receiving space 11 of the pen body 10. The cleaning part 20 has various forms. It can be a large piece of soft cloth shown in FIG. 6, or a bundle of soft fibers shown in FIG. 5, a small piece of soft cloth as shown in FIG. 4, or a soft cloth buff as shown in FIG. 7. According to users' needs, the cleaning part 20 can be moved out of the receiving space 11 of the pen body 10 to be washed or replaced.

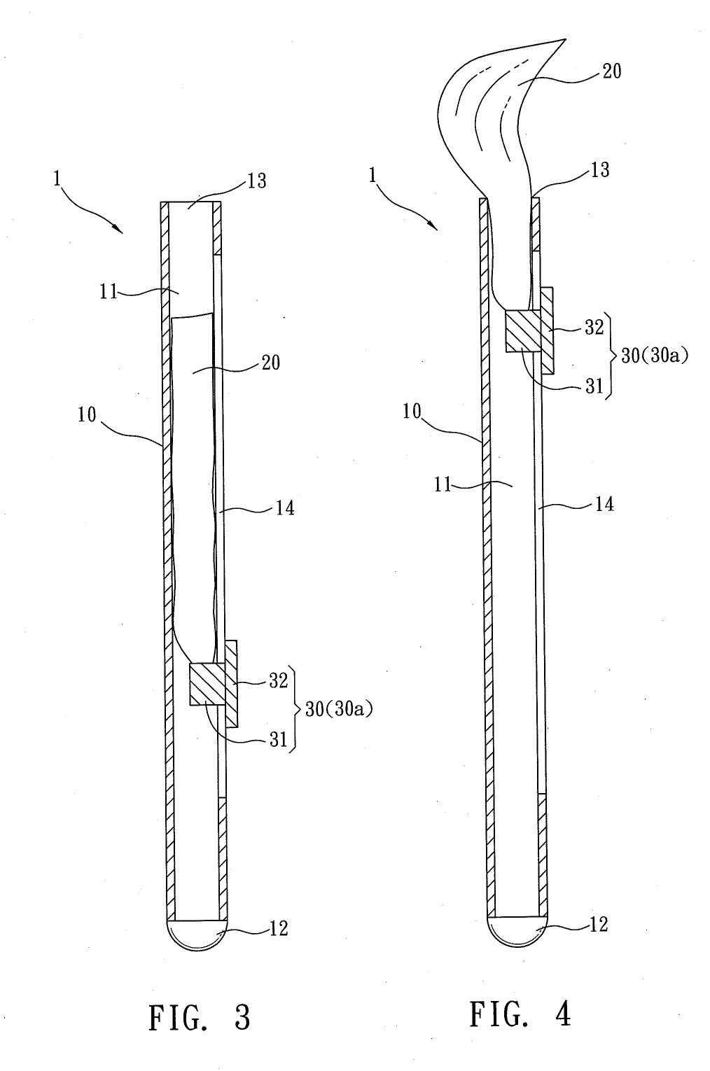

The drive mechanism 30 having a first connection part 31 and an operation part 32 is inserted through and arranged at the second opening 14 of the pen body 10. The connection part 31 is located in the receiving space 11 of the pen body 10 and is connected to one end of the cleaning part 20. The operation part 32 is connected to one end of the connection part 31 and is exposed outside the pen body 10 so that users can make the drive mechanism 30 move by operating the operation part 32. When the user moves the operation part 32 of the drive mechanism 30, a part of or the whole cleaning part 20 is moved out through the first opening 13 of the pen body 10 (as shown in FIG. 4) to wipe the touch screen 2a. After finishing wiping, the cleaning part 20 is retracted and stored in the receiving space 11 of the pen body 10 (as shown in FIG. 3). There are various embodiments of the drive mechanism 30 according to the present invention.

Refer to FIG. 4 and FIG. 5, the drive mechanism 30 is a push button 30a having the connection part 31 and the operation part 32 on two ends thereof. Corresponding to the push button 30a, the first opening 13 and the second opening 14 of the pen body 10 are respectively disposed on the rear end and side surface of the pen body 10. The second opening 14 is designed into a long slot mounted along the lengthwise direction of the pen body 10. The connection part 31 is located in the receiving space 11 of the pen body 10 and is connected to one end of the cleaning part 20 while the operation part 32 is exposed outside the pen body 10. By operating the operation part 32, the push button 30a (drive mechanism 30) is moved forward and backward along the long second opening 14. When the push button 30a (drive mechanism 30) is pushed outward, the cleaning part 20 is passed through the first opening 13 of the pen body 10 to be moved out, as shown in FIG. 4. When the push button 30a (drive mechanism 30) is pushed inward, the cleaning part 20 is retracted into the receiving space 11 of the pen body 10, as shown in FIG. 3. In this embodiment, the cleaning part 20 is moved in and out along an axial direction (lengthwise direction) of the pen body 10.

Refer to FIG. 6, the drive mechanism 30 is formed by an axis 30b and a handle button 30c. The axis 30b is used as the connection part 31 while the handle button 30c is connected to one end of the axis 30b, working as the operation part 32. The first opening 13 and the second opening 14 are respectively corresponding to the axis 30b and the handle button 30c and are located at the side surface and the rear end of the pen body 10. The first opening 13 is a long slot mounted along the lengthwise direction of the pen body 10. The length of the first opening 13 is a bit larger than the width of the cleaning part 20. The axis 30b (connection part 31) is arranged in the receiving space 11 of the pen body 10, connected to one end of the cleaning part 20 and wrapped by the cleaning part 20. The handle button 30c (operation part 32) is rotatable and is arranged at the rear end of the pen body 10. By rotating the handle button 30c counterclockwise (as an arrow A indicated), the axis 30b is synchronously rotated to drive the cleaning part 20 passing through the first opening 13 of the pen body 10 and moving out (as the solid arrow indicated). Or the handle button 30c is rotated clockwise (as an arrow B indicated) to drive the cleaning part 20 moving in (as the dotted indicated) to be retracted and stored in the receiving space 11 of the pen body 10. In this embodiment, the cleaning part 20 is moved in and out along the radial direction of the pen body 10.

Refer to FIG. 7, in this embodiment, the touch screen pen 1 further includes a power component 40. The power component 40 consists of a motor 41 and a power supplier 42 electrically connected to the motor 41 for providing power. The power supplier 42 can be, but not limited to, a button cell battery or a solar cell. The power component 40 is connected to the drive mechanism 30 and is also driven to move. An output end of the power component 40 is connected to one end of the cleaning part 20. In this embodiment, the drive mechanism 30 is connected to one end of the cleaning part 20 by the power component 40. Thereby the power component 40 and the cleaning part 20 are driven to move by the drive mechanism 30 so that the cleaning part 20 is exposed out of the pen body 10. Then the power component 40 is turned on to drive the cleaning part 20 to rotate for wiping and cleaning the touch screen 2a of the electronic device 2. This embodiment provides users convenience and novelty in use by a wiping contact of electric rotation. Moreover, the motor 41 is a mini-motor able to be mounted in the pen body 10.

Furthermore, the first opening 13 of the pen body 10 is further disposed with a protection element 15 that covers the first opening 13 to prevent the cleaning part 20 mounted in the pen body 10 from being polluted and enhance the aesthetic appearance of the touch screen pen 1. The protection element 15 can be a cover, as shown in FIG. 8 or a plug, as shown in FIG. 9.

In summary, the touch screen pen with cleaning function of the present invention has following advantages:

(1). The present invention includes a cleaning part 20 disposed in a pen body 10 of a touch screen pen 1. The cleaning part 20 is driven by a drive mechanism 30 to move out for wiping and cleaning a touch screen 2a. After finishing the cleaning, the cleaning part 20 is driven to move in opposite direction and retract into the pen body 10. The touch screen pen of the present invention is easy to carry and convenient in use. Thus the user's needs are met.
(2). The touch control pan 1 of the present invention has simple structure. Thus the manufacturing cost is down and is suitable for mass-production. Thus not only the user's needs, the manufacturer's requirements are also met.

What is claimed is:

1. A touch screen pen with cleaning function applied to an electronic with a touch screen comprising:
a pen body having a front end, a rear end, and a side surface with a certain length and formed between the front end and the rear end; a receiving space is formed in the pen body and a touch control end is disposed on the front end for control of the touch screen; the pen body is arranged with a first opening and a second opening; the first opening and the second opening are communicating with the receiving space so that the receiving space is communicating with space outside the pen body through the first opening;
at least one cleaning part that is mounted in the receiving space and is corresponding to the first opening of the pen body; a part of or the whole cleaning part is able to be moved out and in the pen body through the first opening; and
a drive mechanism that is inserted through and arranged at the second opening of the pen body and having a connection part and an operation part connected to one end of the connection part; the connection part is located in the receiving space of the pen body and is connected to one end of the cleaning part while the operation part is exposed outside the pen body and is used to be operated;
wherein users can operate the operation part to drive the cleaning part moving out through the first opening of the pen body for wiping the touch screen; after finishing wiping, the cleaning part is driven to move into the receiving space of the pen body for storage.

2. The device as claimed in claim 1, wherein the second opening is a long slot arranged at the side surface along a lengthwise direction of the pen body while the first opening is disposed on the rear end of the pen body; the drive mechanism is able to be moved along a lengthwise direction of the second opening.

3. The device as claimed in claim 2, wherein the first opening on the rear end of the pen body is arranged with a protection element used for covering the first opening.

4. The device as claimed in claim 3, wherein the protection element is a cover or a plug.

5. The device as claimed in claim 1, wherein the second opening is disposed on the rear end of the pen body while the first opening is set on the side surface of the pen body; a shape of the second opening is the same as or similar to a cross section of the pen body; the drive mechanism is able to be rotated counterclockwise or clockwise along the second opening.

6. The device as claimed in claim 1, wherein the drive mechanism is a push button; the connection part and the operation part are respectively located on two ends of the push button.

7. The device as claimed in claim 1, wherein the drive mechanism includes an axis and a handle button; the axis is used as the connection part while the handle button is used as the operation part.

8. The device as claimed in claim 1, wherein a shape of the pen body is selected from the group consisting of a cylindrical tube, an elliptical tube, a square tube, a rectangular tube, a conic tube with the smaller front end and the larger rear end, and a pyramidal tube with the smaller front end and the larger rear end.

9. The device as claimed in claim 1, wherein the cleaning part is in a form selected from the group consisting of a large piece of soft cloth, a bundle of soft fibers, a small piece of soft cloth, and a soft cloth buff.

10. The device as claimed in claim 1, wherein the touch screen pen further includes a power component; the power component is composed of a motor and a power supplier for providing the motor power; the power component is connected to and is driven by the drive mechanism; an output end of the power component is connected to one end of the cleaning component; the power component and the cleaning part are driven to move by the drive mechanism so that the cleaning part is exposed outside the pen body and then the power component is turned on for driving the cleaning part to work and wipe.
